(19) United States
(12) Patent Application Publication
(10) Pub. No.: US 2026/0258561 A1
(43) Pub. Date: Sep. 3, 2026

(54) METHOD FOR PRODUCING CARBOXYLIC ACID

(71) Applicant: TOYOTA JIDOSHA KABUSHIKI KAISHA, Toyota-shi (JP)

(72) Inventor: Haruyuki NAKANISHI, Nagoya-shi (JP)

(73) Assignee: TOYOTA JIDOSHA KABUSHIKI KAISHA, Toyota-shi (JP)

(21) Appl. No.: 19/395,529

(22) Filed: Nov. 20, 2025

(30) Foreign Application Priority Data
Feb. 28, 2025 (JP) 2025-032362

(51) Int. Cl. C25B 3/07; C25B 3/26; C25B 9/13; C25B 9/17; C25B 11/046; C25B 15/08; H01M 4/52

(52) U.S. Cl. CPC C25B 3/07; C25B 3/26; C25B 9/13; C25B 9/17; C25B 11/046; C25B 15/08; H01M 4/52

(57) ABSTRACT

A method for producing a carboxylic acid by reducing carbon dioxide in the atmosphere includes: a step of subjecting a hydrogen storage alloy negative electrode used in a nickel metal hydride battery to a treatment in which the hydrogen storage alloy negative electrode is immersed in an alkaline electrolyte solution and then dried; and a step of reducing the carbon dioxide in an electrolytic cell including an alkaline electrolyte solution configured to adsorb the carbon dioxide, a positive electrode used in a nickel metal hydride battery, the hydrogen storage alloy negative electrode after the treatment, and a power supply connected to the positive electrode and the hydrogen storage alloy negative electrode, by applying a potential difference across the positive electrode and the hydrogen storage alloy negative electrode such that a potential of the positive electrode is higher than a potential of the hydrogen storage alloy negative electrode.

### CROSS-REFERENCE TO RELATED APPLICATION

This application claims priority to Japanese Patent Application No. 2025-032362 filed on Feb. 28, 2025. The disclosure of the above-identified application, including the specification, drawings, and claims, is incorporated by reference herein in its entirety.

### BACKGROUND

### 1. Technical Field

The present disclosure relates to methods for producing a carboxylic acid.

### 2. Description of Related Art

Carbon dioxide (CO₂) is one of greenhouse gases that naturally exist in the atmosphere and that are generated by the combustion of fossil fuels. Due to human activities and increasing energy demand, atmospheric CO₂ levels have increased, which is believed to cause global warming. Removal of CO₂ from the atmosphere has attracted the attention of many researchers around the world. Various CO₂ conversion methods, including chemical, photocatalytic, and electrochemical methods, have been widely studied.

A method is known in which carbon dioxide is reduced using an electrochemical cell and the resulting products are extracted in situ. In this method, an absorbent containing CO₂ is introduced to the cathode, where CO₂ is electrochemically reduced to form products such as organic acids. These products are then extracted and collected in situ. Multiple separators are arranged between the anode and the cathode to maintain an efficient reaction environment (Japanese Unexamined Patent Application Publication (Translation of PCT Application) No. 2024-517246 (JP 2024-517246 A)). A photocatalytic technique is also known in which specific catalytic materials are fixed to a substrate and visible light is used to convert carbon dioxide into acetic acid or formic acid. In this method, a mixed sol is prepared by collectively encapsulating, with an organic solid-solution binder, an electron-acceptor slurry containing tungsten oxide fine particles, a ruthenium (Ru)-based dye, ethyl viologen dichloride, and an artificial acetic acid bacteria enzyme, and a substrate is coated with the mixed sol. Carbon dioxide is thus converted into acetic acid or formic acid using a photocatalytic reaction (Japanese Unexamined Patent Application Publication No. 2022-76331 (JP 2022-76331 A)).

### SUMMARY

In conventional methods, electrochemical approaches require a separator in the configuration of an electrolytic cell, while photocatalytic techniques require a substrate using specific elements.

An object of one embodiment of the present disclosure is to provide a method for producing a carbon-neutral carboxylic acid efficiently and with a low environmental impact.

Means for achieving the above object include the following aspects.
(1) A method for producing a carboxylic acid by reducing carbon dioxide in the atmosphere, the method including:

a step of subjecting a hydrogen storage alloy negative electrode used in a nickel metal hydride battery to a treatment in which the hydrogen storage alloy negative electrode is immersed in an alkaline electrolyte solution and then dried; and a step of reducing the carbon dioxide in an electrolytic cell including an alkaline electrolyte solution configured to adsorb the carbon dioxide, a positive electrode used in a nickel metal hydride battery, the hydrogen storage alloy negative electrode after the treatment, and a power supply connected to the positive electrode and the hydrogen storage alloy negative electrode, by applying a potential difference across the positive electrode and the hydrogen storage alloy negative electrode such that the potential of the positive electrode is higher than the potential of the hydrogen storage alloy negative electrode.
(2) The method according to (1), wherein: the hydrogen storage alloy negative electrode contains MmNi₅; and the positive electrode contains either or both of Ni(OH)₂ and NiOOH.
(3) The method according to (1) or (2), wherein the hydrogen storage alloy negative electrode after the treatment has a diffraction peak in a range of 2θ=32° to 33° in X-ray diffraction (XRD) measurement.
(4) The method according to any one of (1) to (3), wherein the alkaline electrolyte solution contains water and at least one selected from KOH, K₂CO₃, Na₂CO₃, and KHCO₃.
(5) The method according to any one of (1) to (4), wherein the carboxylic acid includes at least one selected from formic acid, acetic acid, and propionic acid.

One embodiment of the present disclosure provides a method for producing a carbon-neutral carboxylic acid efficiently and with a low environmental impact.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the X-ray diffraction results of MmNi₅-based hydrogen storage alloy cathodes in examples and comparative examples.

### DETAILED DESCRIPTION OF EMBODIMENTS

An embodiment of the present disclosure will be described below with reference to the drawings.

In the present disclosure, numerical ranges indicated using “to” represent ranges inclusive of minimum and maximum values specified before and after “to”, respectively.

Among the numerical ranges described in stages in the present disclosure, the upper or lower limit of one numerical range may be replaced with the upper or lower limit of another numerical range. In addition, in the numerical ranges described in the present disclosure, the upper or lower limit of a numerical range may be replaced with a value disclosed in the examples.

In the present disclosure, the term “step” includes not only an independent step, but also a step that is not clearly distinguishable from other steps, as long as the intended purpose of the step is achieved.

In the present disclosure, a combination of two or more preferable aspects is considered a more preferable aspect.

In the present disclosure, the “anode” in an electrolytic reaction is also referred to as the “positive electrode,” and the “cathode” is also referred to as the “negative electrode.”

### Method for Producing Carboxylic Acid

The method for producing a carboxylic acid according to the present disclosure is a method for producing a carboxylic acid by reducing carbon dioxide in the atmosphere, and includes a treatment step and a reduction step. In the treatment step, a hydrogen storage alloy negative electrode that is employed in a nickel metal hydride battery is immersed in an alkaline electrolyte solution and then dried. In the reduction step, carbon dioxide is reduced in an electrolytic cell by applying, with a power supply, a potential difference across the positive electrode and the negative electrode such that the potential of the positive electrode is higher than that of the negative electrode. The electrolytic cell includes an alkaline electrolyte solution, a positive electrode, a negative electrode, and a power supply. The alkaline electrolyte solution is capable of adsorbing carbon dioxide. The positive and negative electrodes are electrodes that are employed in a nickel metal hydride battery, and the negative electrode is subjected to pretreatment by the treatment step before being used for electrolysis. The power supply is connected to the positive and negative electrodes. Hereinafter, the alkaline electrolyte solution is also referred to as “electrolyte solution.”

### Treatment Step

In the treatment step, the hydrogen storage alloy negative electrode may be any negative electrode containing a hydrogen storage alloy that is employed in a nickel metal hydride battery (that is, a nickel metal hydride secondary battery (Ni-MH)). From the viewpoint of environmental impact, an AB₅-type hydrogen storage alloy, which is widely used in nickel metal hydride batteries, is preferable as the hydrogen storage alloy, a hydrogen storage alloy based on mischmetal is more preferable, and a hydrogen storage alloy containing MmNi₅ is still more preferable. The hydrogen storage alloy negative electrode may be one before use in a battery, or one included in a used nickel metal hydride battery.

The alkaline electrolyte solution is preferably one that is employed in a nickel metal hydride battery. The alkaline electrolyte solution may be one that has not yet been used in a nickel metal hydride battery, or one that has been used in a nickel metal hydride battery. The alkaline electrolyte solution may be of a single type or a mixture of multiple types. The alkaline electrolyte solution may be of the same type as the alkaline electrolyte solution that is employed in the electrolytic cell.

Examples of the alkaline electrolyte solution include an aqueous potassium carbonate (K₂CO₃) solution, an aqueous potassium hydroxide (KOH) solution, an aqueous potassium bicarbonate (KHCO₃) solution, an aqueous sodium hydroxide (NaOH) solution, an aqueous sodium carbonate (Na₂CO₃) solution, and an aqueous lithium hydroxide (LiOH)

### Solution

From the viewpoint of carboxylic acid production, it is preferable that the alkaline electrolyte solution contain water and at least one selected from KOH, K₂CO₃, and Na₂CO₃. Since an aqueous KOH solution becomes an aqueous K₂CO₃ solution or an aqueous KHCO₃ solution through adsorption of CO₂ in the atmosphere, an aqueous KOH solution that has been brought into contact with air may be used as the alkaline electrolyte solution.

The method for immersing the hydrogen storage alloy negative electrode in the alkaline electrolyte solution is not limited. Any method may be used as long as the hydrogen storage alloy negative electrode is partially or entirely immersed in the alkaline electrolyte solution. When the hydrogen storage alloy negative electrode is one included in a used nickel metal hydride battery, the hydrogen storage alloy negative electrode has already been immersed in an alkaline electrolyte solution. Therefore, the hydrogen storage alloy negative electrode removed from the used nickel metal hydride battery may be used as is.

The hydrogen storage alloy negative electrode immersed in the alkaline electrolyte solution is then dried. The drying does not have to be complete drying such as removal of all moisture, and may be to the extent that the alkaline electrolyte solution adhering to the hydrogen storage alloy negative electrode is concentrated.

The inventors have found that, by using in an electrolytic cell a hydrogen storage alloy negative electrode dried with an alkaline electrolyte solution adhering thereto, the resistance of the hydrogen storage alloy negative electrode in the alkaline electrolyte solution is significantly reduced. Although the reason for this is not clear, it is presumed that a change in the surface state activates the surface of the hydrogen storage alloy negative electrode, thereby causing carboxylic acids to be produced in electrolysis. One possible example of such a change in the surface state is that at least part of the components of the alkaline electrolyte solution are present as crystals on the surface. It is presumed that, as a result, a localized strongly alkaline environment etc. is maintained, whereby carboxylate ions such as formate ions, acetate ions, and propionate ions are formed in the CO₂ reduction reaction.

From the viewpoint of producing a carboxylic acid, the drying temperature is preferably relatively low. As an example, drying is performed in air at 80° C. for several hours. Although the drying conditions are not limited to these, it is presumed that drying at a relatively low temperature produces crystals that adhere relatively uniformly.

The hydrogen storage alloy negative electrode treated in the treatment step preferably has a diffraction peak in the range of 2θ=32° to 33° in X-ray diffraction (XRD) measurement. This diffraction peak in the range of 2θ=32° to 33° is not present in the XRD measurement result of the hydrogen storage alloy negative electrode before treatment, and is a diffraction peak newly observed in the treated hydrogen storage alloy negative electrode. It is presumed that, as a result of the treatment step described above, crystals of KOH, which is a component of the alkaline electrolyte solution, are present on part of the surface of the treated hydrogen storage alloy negative electrode, and that a diffraction peak derived from these KOH crystals is newly observed in the range of 2θ=32° to 33°. The treated hydrogen storage alloy negative electrode also has a peak derived from the hydrogen storage alloy itself before treatment.

### Reduction Step

The reduction step uses an electrolytic cell. The alkaline electrolyte solution contained in the electrolytic cell is capable of adsorbing carbon dioxide (CO₂), and may be the same as the alkaline electrolyte solution used in the treatment step. The alkaline electrolyte solution preferably contains KOH, KHCO₃, and K₂CO₃. Since an aqueous KOH solution becomes an aqueous K₂CO₃ solution or an aqueous KHCO₃ solution through adsorption of CO₂ in the atmosphere, an aqueous KOH solution that has been brought into contact with air may be used as the alkaline electrolyte solution. The alkaline electrolyte solution contained in the electrolytic cell may be the same as the electrolyte solution in an alkaline secondary battery.

Potassium carbonate (K₂CO₃) reacts with CO₂ in the atmosphere (400 ppm, 40 Pa) in the presence of water to produce potassium bicarbonate (KHCO₃). This reaction is represented by the following equation (1).

$${K}_{2} {CO}_{3} + {CO}_{2} + {H}_{2} O ← \to 2 {KHCO}_{3} \qquad ( 1 )$$

In the van't Hoff equation shown in the following equation (2), ΔH⁰ represents the standard enthalpy change (−96.1 KJ/mol CO₂), ΔS⁰ represents the standard entropy change (−208 J/Kmol CO₂). The atmospheric pressure (0.1 MPa) is substituted for P₀, the gas constant (8.314 JK⁻¹ mol⁻¹) for R, and the temperature (298 K) for T. As a result, the pressure P is 0.112 Pa and the equilibrium concentration of CO₂ absorption is 1.12 ppm. This shows that potassium carbonate (K₂CO₃) can absorb carbon dioxide in the atmosphere (400 ppm), and potassium bicarbonate (KHCO₃) is used electrochemically as a CO₂ source. Thereafter, potassium bicarbonate (KHCO₃) is regenerated to potassium carbonate (K₂CO₃).

### (Math. 1)

$$ln ( \frac{P}{{P}_{0}} ) = \frac{Δ {H}^{0}}{RT} - \frac{Δ {S}^{0}}{R} \qquad ( 2 )$$

Since an aqueous KOH solution becomes an aqueous K₂CO₃ solution or an aqueous KHCO₃ solution through adsorption of CO₂ in the atmosphere, an aqueous KOH solution that has been brought into contact with air may be used. KOH absorbs CO₂ (400 ppm) in the atmosphere to partially generate potassium carbonate (K₂CO₃) and water. This reaction is represented by the following equation (3).

$$2 KOH + {CO}_{2} ← \to {K}_{2} {CO}_{3} + {H}_{2} O \qquad ( 3 )$$

In the van't Hoff equation shown in the above equation (2), ΔH⁰ represents the standard enthalpy change (−194 KJ/mol CO₂), ΔS⁰ represents the standard entropy change (−151 J/Kmol CO₂). The atmospheric pressure (0.1 MPa) is substituted for P₀, the gas constant (8.314 JK⁻¹ mol⁻¹) for R, and the temperature (298 K) for T. As a result, the pressure P is 0.112 Pa and the equilibrium concentration of CO₂ absorption is 7.92×10⁻²¹ ppm. This shows that KOH can absorb carbon dioxide in the atmosphere. Since K₂CO₃ is thermodynamically stable, the aqueous K₂CO₃ solution described above is considered to allow K₂CO₃ to be more effectively used as a CO₂ source for carboxylic acid production than an aqueous KOH solution, and is therefore preferable as an alkaline electrolyte solution. When an aqueous KOH solution is used as the alkaline electrolyte solution in an electrolytic cell, electrolysis may be performed by, for example, increasing the potential difference.

The alkaline electrolyte solution may be an electrolyte solution contained in a nickel metal hydride battery (that is, a nickel metal hydride secondary battery (Ni-MH)). The electrolyte solution may be an electrolyte solution contained in a nickel metal hydride battery before use or an electrolyte solution contained in a used nickel metal hydride battery. The alkaline electrolyte solution may contain trace elements or compounds other than those described above.

Regarding the electrodes provided in the electrolytic cell, a positive electrode that is employed in a nickel metal hydride battery is used as the positive electrode. It is preferable that the positive electrode contain either or both of Ni(OH)₂ and NiOOH. Elements other than Ni(OH)₂ or NiOOH, such as Co or Fe, may be added to the positive electrode. The positive electrode may be a positive electrode included in a nickel metal hydride battery before use or a positive electrode included in a used nickel metal hydride battery.

From the standpoint of carboxylic acid production, it is preferable that the positive electrode be subjected to the same treatment step as the negative electrode. The treatment for the positive electrode is the same as that for the negative electrode.

The power supply is not limited as long as it is capable of performing electrolysis using an electrolytic cell. Carbon dioxide is reduced by applying a potential difference across the positive electrode and the negative electrode from the power supply such that the potential of the positive electrode is higher than that of the negative electrode. It is preferable to use a power supply that does not use fossil fuels etc. This is because carboxylic acids that serve as raw materials for fuels can be produced from carbon dioxide in the atmosphere with lower environmental impact.

Electrolysis is performed by the electrolytic cell in a state in which the alkaline electrolyte solution can be in contact with the atmosphere. As a result, CO₂ adsorbed by the alkaline electrolyte solution can be electrochemically reduced. In the method for producing a carboxylic acid according to the present disclosure, carboxylate ions are generated by the reduction of CO₂, and it is considered that many of them exist also as potassium carboxylate in the alkaline electrolyte solution. The alkaline electrolyte solution containing potassium carboxylate is recovered, and a carboxylic acid can be recovered by neutralizing this electrolyte solution.

In the method for producing a carboxylic acid according to the present disclosure, carboxylate ions may be generated. The carboxylate ions may include at least one selected from formate ions, acetate ions, and propionate ions. In the method for producing a carboxylic acid according to the present disclosure, an alcohol such as methanol may also be generated. Oxygen is generated from the positive electrode by electrolysis. The generated oxygen may be released into the atmosphere or may be recovered and used.

With the method for producing a carboxylic acid according to the present disclosure, carboxylic acids including acetic acid that serves as a raw material for, for example, vinegar, polymers, or ethanol as a fuel can be produced from carbon dioxide in the atmosphere by electrolysis. The electrolytic cell used for electrolysis may utilize the electrodes and electrolyte solution of a used nickel metal hydride battery. The method for producing a carboxylic acid according to the present disclosure can be performed by, for example, opening a used nickel metal hydride battery, removing the negative electrode, subjecting the negative electrode to the treatment step, and then returning it to the battery, followed by applying a potential difference across the electrodes. Even in cases where an electrolyte solution, a positive electrode, or a negative electrode that has not been used in a nickel metal hydride battery are used, the existing components can be used as they are. Accordingly, with the method for producing a carboxylic acid according to the present disclosure, a carbon-neutral carboxylic acid can be produced efficiently and with a low environmental impact.

The present disclosure will now be described in further detail with reference to examples. The examples of the present specification are illustrative and not intended to be limiting. It will be understood by those skilled in the art to which the present disclosure pertains that materials, compositions, manufacturing methods, and applications may be modified, altered, or substituted as appropriate without departing from the spirit and scope of the disclosure. The term “Ni(OH)₂/NiOOH positive electrode” means that the positive electrode contains either Ni(OH)₂ or NiOOH, and may contain both.

### Measurement Method

In the following Examples and Comparative Examples, after electrolysis was performed under predetermined conditions using an electrolytic cell, ion chromatography analysis was conducted to measure the amounts of formate ions, acetate ions, and propionate ions generated. The generated amounts were measured on a mass basis. The measurement results are shown in Table 1.

### Example 1

A nickel metal hydride battery was disassembled, and an Ni(OH)₂/NiOOH positive electrode and an MmNi₅-type hydrogen storage alloy negative electrode were removed. The positive electrode used was one that had been immersed in water and subsequently dried. The hydrogen storage alloy negative electrode used in the treatment step was one that had been dried after removal from the nickel metal hydride battery. The drying was performed in air at 80° C. for three hours. The positive electrode was used as the anode and the negative electrode as the cathode, and a 2.5 M (mol/L; the same applies hereinafter) aqueous KHCO₃ solution was used as the electrolyte solution. Electrolysis experiments were conducted in air. The electrolysis conditions were as follows: the electrode area was 6 cm² for both the anode and the cathode, the current density was 50 mA/cm², the current was kept constant at 300 mA, the electrolysis time was 24 hours, the temperature was 30° C., and the electrolyte volume was 200 mL. Thereafter, ion chromatography analysis was performed on the electrolyte solution. The amounts of formate ions, acetate ions, and propionate ions generated by the electrolysis, and the total amount of these ions as the generated amount of carboxylate ions, are shown in Table 1.

### Example 2

Electrolysis experiments were conducted in the same manner as in Example 1 except that the electrolyte solution of the electrolytic cell was a 3.5 M aqueous K₂CO₃ solution. The amounts of formate ions, acetate ions, and propionate ions generated by the electrolysis, and the total amount of these ions as the generated amount of carboxylate ions, are shown in Table 1.

### Example 3

Electrolysis experiments were conducted in the same manner as in Example 1 except that the electrolyte solution of the electrolytic cell was an 8 M aqueous KOH solution. The amounts of formate ions, acetate ions, and propionate ions generated by the electrolysis, and the total amount of these ions as the generated amount of carboxylate ions, are shown in Table 1.

### Comparative Example 1

Electrolysis experiments were conducted in air using electrodes made of platinum (Pt) as both the anode and the cathode and using a 2.5 M aqueous KHCO₃ solution as the electrolyte solution. The current was kept constant at 300 mA, and the electrolysis was conducted for 24 hours. Thereafter, ion chromatography analysis was performed on the electrolyte solution. The amounts of formate ions, acetate ions, and propionate ions generated by the electrolysis, and the total amount of these ions as the generated amount of carboxylate ions, are shown in Table 1.

### Comparative Example 2

Electrolysis experiments were conducted in the same manner as in Comparative Example 1 except that the electrolyte solution of the electrolytic cell was a 3.5 M aqueous K₂CO₃ solution. The amounts of formate ions, acetate ions, and propionate ions generated by the electrolysis, and the total amount of these ions as the generated amount of carboxylate ions, are shown in Table 1.

### Comparative Example 3

Electrolysis experiments were conducted in the same manner as in Comparative Example 1 except that the electrolyte solution of the electrolytic cell was an 8 M aqueous KOH solution. The amounts of formate ions, acetate ions, and propionate ions generated by the electrolysis, and the total amount of these ions as the generated amount of carboxylate ions, are shown in Table 1.

TABLE 1

| | | | | Formate | Acetate | Propionate | Carboxylate |
|---|---|---|---|---|---|---|---|
| | | | | Ion | Ion | Ion | Ions |
| | Electrodes | Electrolyte | Atmosphere | (mg/L) | (mg/L) | (mg/L) | (mg/L) |
| Example 1 | Cathode: Heat-treated MmNi₅- | 2.5M | In air | 4 | 3 | 1 | 8 |
| | based hydrogen storage alloy | KHCO₃ | | | | | |
| | Anode: Ni(OH)₂/NiOOH | | | | | | |
| Example 2 | Cathode: Heat-treated MmNi₅- | 3.5M | In air | 1 | 9 | 1 | 11 |
| | based hydrogen storage alloy | K₂CO₃ | | | | | |
| | Anode: Ni(OH)₂/NiOOH | | | | | | |
| Example 3 | Cathode: Heat-treated MmNi₅- | 8M KOH | In air | 3 | 19 | 2 | 24 |
| | based hydrogen storage alloy | | | | | | |
| | Anode: Ni(OH)₂/NiOOH | | | | | | |
| Comparative | Cathode: Pt | 2.5 M | In air | 1 | 3 | 1 | 5 |
| Example 1 | Anode: Pt | KHCO₃ | | | | | |
| Comparative | Cathode: Pt | 3.5 M | In air | 1 | 1 | 1 | 3 |
| Example 2 | Anode: Pt | K₂CO₃ | | | | | |
| Comparative | Cathode: Pt | 8 M KOH | In air | 3 | 3 | 1 | 7 |
| Example 3 | Anode: Pt | | | | | | |

### Example 4

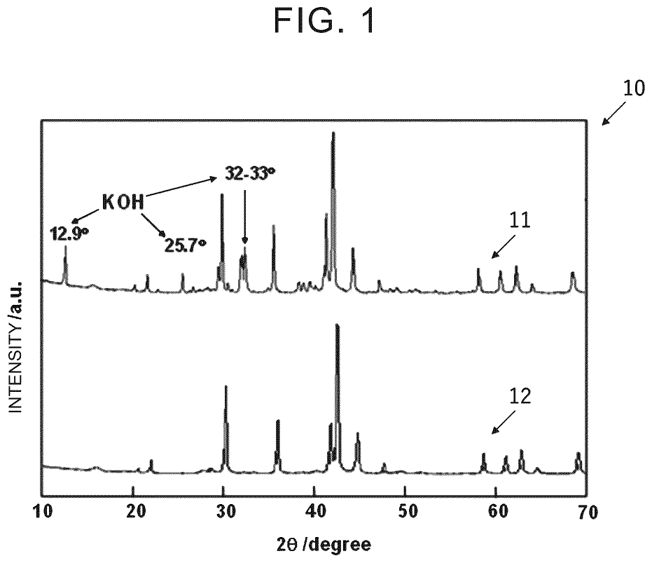

An MmNi₅-based hydrogen storage alloy cathode removed from a nickel metal hydride battery was subjected to heat treatment in air at 80° C. for three hours. An X-ray diffraction intensity curve of the heat-treated MmNi₅-based hydrogen storage alloy cathode is shown in FIG. 1.

### Comparative Example 4

An X-ray diffraction intensity curve of an MmNi₅-based hydrogen storage alloy cathode removed from a nickel metal hydride battery, washed, and not subjected to the treatment step is shown in FIG. 1.

As a result of the heat treatment of the MmNi₅-based alloy in Example 4, a new peak that was not present in Comparative Example 4 was observed at 2θ=32° to 33°. This peak is considered to result from crystallization of KOH used as the electrolyte in the nickel metal hydride battery. Additional new peaks were observed at 12.9° and 25.7°. These peaks are also considered to result from crystallization of KOH used as the electrolyte in the nickel metal hydride battery.

What is claimed is:

1. A method for producing a carboxylic acid by reducing carbon dioxide in an atmosphere, the method comprising:
a step of subjecting a hydrogen storage alloy negative electrode used in a nickel metal hydride battery to a treatment in which the hydrogen storage alloy negative electrode is immersed in an alkaline electrolyte solution and then dried; and
a step of reducing the carbon dioxide in an electrolytic cell including an alkaline electrolyte solution configured to adsorb the carbon dioxide, a positive electrode used in a nickel metal hydride battery, the hydrogen storage alloy negative electrode after the treatment, and a power supply connected to the positive electrode and the hydrogen storage alloy negative electrode, by applying a potential difference across the positive electrode and the hydrogen storage alloy negative electrode such that a potential of the positive electrode is higher than a potential of the hydrogen storage alloy negative electrode.

2. The method according to claim 1, wherein:
the hydrogen storage alloy negative electrode contains MmNi₅; and
the positive electrode contains either or both of Ni(OH)₂ and NiOOH.

3. The method according to claim 1, wherein the hydrogen storage alloy negative electrode after the treatment has a diffraction peak in a range of 2θ=32° to 33° in X-ray diffraction measurement.

4. The method according to claim 1, wherein the alkaline electrolyte solution contains water and at least one selected from KOH, K₂CO₃, Na₂CO₃, and KHCO₃.

5. The method according to claim 1, wherein the carboxylic acid includes at least one selected from formic acid, acetic acid, and propionic acid.
